(19) United States
(12) Patent Application Publication
(10) Pub. No.: US 2025/0053393 A1
(43) Pub. Date: Feb. 13, 2025

(54) SOURCE AND MODEL FRAMEWORK

(71) Applicant: LiveIntent, Inc., New York, NY (US)

(72) Inventors: Søren Holbech, Vejle (DK); Niels Boldt, Brønshøj (DK)

(21) Appl. No.: 18/766,531

(22) Filed: Jul. 8, 2024

Related U.S. Application Data
(60) Provisional application No. 63/525,705, filed on Jul. 9, 2023.

(51) Int. Cl. G06F 8/41; G06F 8/36; G06F 8/73

(52) U.S. Cl. CPC G06F 8/41; G06F 8/36; G06F 8/73

(57) ABSTRACT

The inventions disclosed herein relate to frameworks for abstracting specifics, and in particular to frameworks for abstracting specifics about datasets from jobs and frameworks for specifying models for data in data sets. Objects in a data stream can be described by the same non-recursive data model, which may be declared for example as a non-recursive Scala type in the framework.

### BACKGROUND OF THE INVENTION

### Field of Invention

The inventions disclosed herein generally relate to frameworks for abstracting specifics. More particularly, the inventions disclosed herein relate to frameworks for abstracting specifics about datasets from jobs and frameworks for specifying models for data in data sets. Exemplary data sets may include, for example, data such as data location, compression format, encoding, validation, and partitioning.

### BRIEF DESCRIPTION OF THE DRAWINGS

FIG. 1 illustrates source and model definition and compile time and runtime.

FIG. 2 illustrates a code snippet.

FIG. 3 illustrates exemplary potential system elements.

### DETAILED DESCRIPTION OF EMBODIMENTS OF THE INVENTION

The framework itself may be very generic so it allows for all sorts of datasets even pseudo-datasets such as a stream of objects received from a web service endpoint. A primary preferred requirement is that all objects in a data stream can be described by the same non-recursive data model, which may be declared for example as a non-recursive Scala type in the framework.

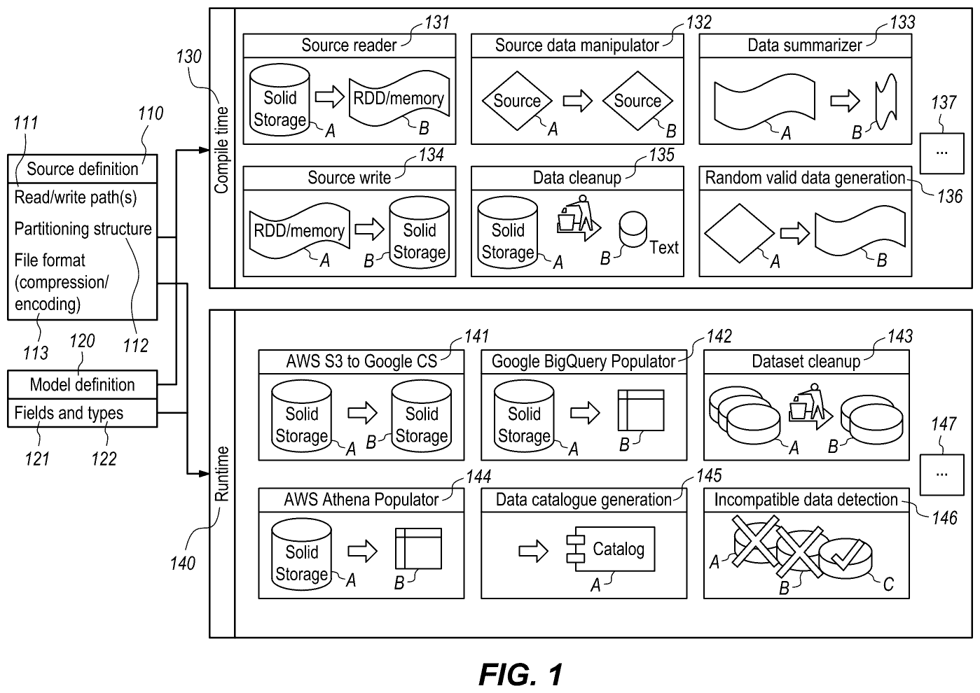

An example framework structure is illustrated in FIG. 1.

The basic premise is that data sources may be described as a pair of, e.g., Scala case classes. One encapsulates the structure of each element in the data source (the “model”), and the other encapsulates the specifics of accessing the data source (the “source”). Partitioning the information as such allow for reuse of models for separate sources. From the two Scala case classes, implicit derivation of type classes allow for functionality at compile time (the top part of the figure). This tends to be functionality for specific sources, such as automatically generated code to read the source in a data processing job, or for validating the elements in it. There is also functionality which may only be available at runtime (the bottom part of the figure). This functionality may be derived by a combination of implicit resolution and reflection. The need for reflection arises when one needs to enumerate sources, which is needed for creating jobs that automatically delete stale data, or replicates data across more systems, but some runtime functionality is also dependent on actual data, such as detection of incompatible data, and therefore cannot be gotten at compile time.

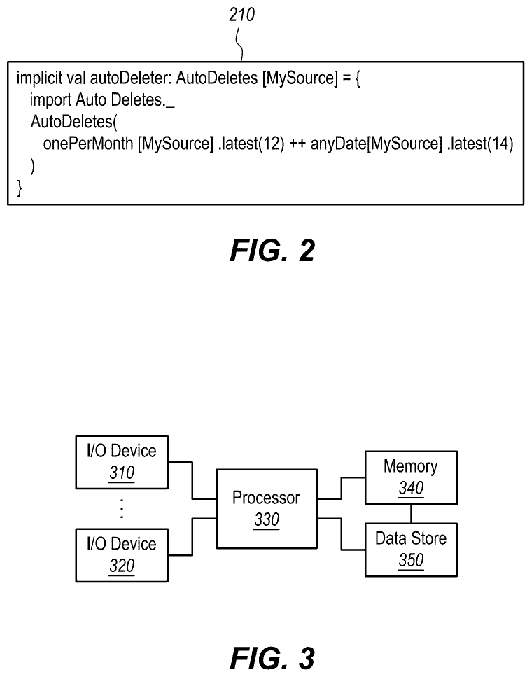

Features offered as a part of source framework may include:
1) Automatic generation of end-user documentation for all datasets. All datasets may be documented as code and comments in the code. The strong type system of Scala allows for most documentation to happen as code in data models and source abstractions as they are programmed, but additional semantics and caveats can be added as comments in standard Scaladoc style. This information (code structure and comments) are preferably extracted by a custom piece of reflection code in the framework, stored in generic form in the cloud and is then read by any number of custom programs that create the end-user documentation needed.
2) Automatic replication to e.g. Athena/BigQuery/RedShift/etc. of new and old datasets. An exemplary flow may be using reflection all declared sources are enumerated, and implicit resolution generates for each the path to the S3-data, the partitioning template, and translation into JSON of the corresponding model data structure. A separate python program may read those informations and use e.g. the AWS API to register partitions and add/remove/change AWS Glue definitions to match the structure of the model.
3) Ability to read most recent version of dataset automatically in jobs. At compile time a type class based on the partition structure of the source is derived using implicit resolution which can at runtime search S3 for legal partitions of the source and change the source to read the most recent of these.
4) Handles missing data automatically. Source case classes marked with a specific trait get treated differently by the rules for implicit resolution of code that reads the sources at runtime. If the trait is there, the constructed source reader will preferably substitute an empty pipe instead of attempting to read the data if an initial check has indicated that data is not available for the date being asked for.
5) Plugin-based 6) Automatic deletion of old datasets based on retention rules. Rules may be defined in a simple language containing constructs for keeping one date per month, week, etc. An example can be seen in FIG. 2, which declares that all data in the MySource source should be deleted, unless it is one of the last 14 days of data, or it is required to make sure that at least one day is available from each of the last 12 months.
7) All datasets may be documented as code. Each dataset may be declared as two Scala case classes. These preferably use strong types to encode semantics of individual field of the data elements, and the implicit type rules require of the classes that they are completely and consistently defined in order for data to be read/written from/to them.
8) Supports partitioned file structures and 9) Abstracts away source—and file system (e.g. S3, HDFS, local filesystem, etc.). Each data processing job may contain within it an object that specifies the data area that is being worked on. The type classes that are implicitly generated for reading/writing the sources require such an object and use it to generate the absolute paths to e.g. s3/local/HDFS upon read. Without such an object the data processing job will not compile.
10) Easy end to end testing of Spark and Cascading jobs with sources.
   The framework preferably contains an abstraction for unit testing, where a complete data job is invoked on data in memory and where the resultant data streams are verified against in memory data. Each source read by the job will have to have a corresponding memory stream in the test, and each source written will have a corresponding verification step in the test. The source types are used to enforce this correspondence.
11) UI for exploring data sources and how they are used by jobs. The UI may be generated automatically using the same reflection/implicit resolution process described for automatically updating Athena for example. The main difference is that instead of having the subsequent Python program update AWS Glue, instead it creates a UI.
12) Read/Write-logger which records all access to datasets during job execution to a database.

Features offered as a part of the model framework may include:
1) Automatic generation of random and/or blank instances.
   At compile time, in a compiler, implicit resolution is used to recursively generate a type class that can create random/blank objects. If somewhere in the model one uses a data type that is not covered by the rules already defined in the type class definition, one can add a new implicit resolution rule, and that rule will be used along with the others to generate the concrete type class for one's model.
2) Automatic validation of instances possibly using custom rules. This happens as for generation of random/blank instances. Only the type class generated does not generate new instances, but instead recursively checks each field in an instance of the model for having valid values. Custom rules may be created by manually declaring a type class definition for ones model (or part of the model).
3) Detection of functional type changes between consecutive runs. A type class rules

hierarchy defines for each unique model in the code base a hash, which changes whenever any part of that model changes. Say, if a field deep down the model goes from being an integer to a floating point number, then the hash generated by the type class will differ. The source writers generated for sources make sure to note in a hidden file the type hash for the model of the source that gets written, and the source readers check this noted hash against the hash of the code base it is running on for equivalence. If the check fails the read is rejected. (Unless a command line argument instructing the reader to ignore the mismatch is given.) Note that this check is more intelligent than simply comparing version numbers of builds, as types will most often stay the same across multiple builds, and we do not want to reject reading data generated by a different build unless there is functional difference between the builds on exactly that data model.
4) Strongly typed fields leading to less runtime bugs. The framework encourages usage of strongly typed fields, where say, an IP-address and an email hash are separate types, even though each is really just a string of characters. By having fields typed strongly as thus, it becomes impossible to assign a string that is a hash to a field that expects an IP and vice-versa.
5) Custom enumeration type supporting short names and conversion to bit vectors. Custom types are simply types that are not natively afforded by Scala. In the case of enumeration, Scala's built in type leaves a lot to be desired, and by creating a substitute we can embed it with extra functionality.
6) Custom Avro, Parquet, TSV, JSON and FlatteningTSV writers/readers. Custom here means not customized but rather independently created implementations.

Frameworks may include: A framework for abstracting specifics about datasets, the framework comprising: A plurality of datasets as input sources, where the datasets may include pseudo-datasets; where data sources may be described as a pair of Scala case classes, the first Scala case class encapsulates a source framework structure of each element in the data source, and the second Scala case class encapsulates the model framework specifics of accessing the data source; where from the pair of Scala case classes, implicit derivation of type classes allow for functionality at compile time, the allowed functionality including multiple of: a source reader, a source data manipulator, a data summarizer, and source writer, data cleanup, and random valid data generation; and where all objects in the data stream can be described by the same non-recursive data model.

Frameworks may include: wherein the non-recursive data model may be declared as a non-recursive Scala type; including functionality available at runtime, including one or more of: AWS S3 to Google CS, Google BigQuery Populator, Dataset cleanup, AWS Athena Populator, Data catalog generation, and Incompatible data detection; including automatic generation of end-user documentation for all datasets, as code and code comments, where the code structure and comments are extracted by a custom piece of reflection code in the framework, where the reflection code is stored in generic form in a cloud, and where the reflection code may be read by custom programs that create required end-user documentation; including automatic replication of new and old datasets to one or more of: Athena, BigQuery, and RedShift; including the ability to read the most recent version of a dataset automatically in jobs; including handling unavailable data automatically; including where the framework is plugin-based; including automatic deletion of old datasets based on retention rules; including wherein all datasets are documented as code, and where each dataset may be declared as two Scala classes; including where the source framework supports partitioned file structures; including where the source framework abstracts away source and file systems, each data processing job containing within it an object that specifies the data area being worked on, where the object is used to generate the paths upon read.

Frameworks may include: integrated end to end testing of Spark and Cascading jobs with sources, where the source framework contains an abstraction for unit testing, where a complete data job is invoked on data in memory and where the resultant data streams are verified against in-memory data, where each source read by the job has a corresponding memory stream in a test, and each source written has a corresponding verification step in the test, and where source types are used to enforce this correspondence; including a UI for exploring data sources and how they are used by jobs; including a read/write logger that records access to datasets during job execution to a database; including automatic generation of random and/or blank instances; including automatic validation of instances; including detection of functional type changes between consecutive runs, based on hashes of the code base; including strongly typed fields leading to fewer runtime bugs; including custom enumeration types supporting short names and conversion to bit vectors; including one or more of custom Avro, Parquet, TSV, JSON, and FlatteningTSV writers and/or readers.

For a more complete understanding of various embodiments of the present invention, reference is now made to the following descriptions taken in connection with the accompanying drawings.

FIG. 1 illustrates source definition 110, model definition 120, compile time 130, and runtime 140. As illustrated, source definition 110 may include read/write path(s) 111, partitioning structure 112 and file formatting 113. Read/write path(s) 111 may include one or more read and/or write paths, and relate to Source reader 131 and Source write 134. Partitioning structure 112 relates to Source reader 131 and Source write 134. File formatting 113 may include compression and/or decompression and/or encoding and/or decoding and/or other formatting, and relates to Source reader 131 and Source write 134.

FIG. 1 also illustrates model definition 120, as illustrated including one or more of fields 121 and types 122.

FIG. 1 further illustrates compile time 130, preferably using implicit resolution. Compile time 130 preferably includes: source reader 131, reading from solid storage 131A to RDD/memory 131B; source data manipulator 132, manipulating data from source 132A to source 132B; data summarizer 133, summarizing data to be summarized 133A into summarized data 133B; source writer 134, writing source from RDD/memory 134A to solid storage 134B; data cleanup 135, cleaning up data from solid storage 135A into text 135B; random valid data generator 136, generating random valid data 136B from data 136A; and potentially additional processes 137, for example potentially a blank data generator.

FIG. 1 further illustrates runtime 140, which may use reflection, dynamic compilation, implicit resolution, and APIs, for example possibly Amazon APIs. As illustrated in FIG. 1, runtime 140 preferably includes: AWS S3 to Google CS 141, e.g. from solid storage 141A to solid storage 141B; Google BigQuery populator 142, populating data 142B from solid storage 142A; dataset cleanup 143, cleaning up data 143A into data 143B; AWS Athena

Populator 144, populating data 144B from solid storage 144A; data catalogue generator 145, generating catalog 145A; incompatible data detector 146, detecting incompatible data 146A and 146B, and detecting compatible data 146C; and potentially additional elements 147. Data catalogue generator 145 may include automatic generation of end-user documentation for all datasets, as code and code comments, where the code structure and comments are extracted by a custom piece of reflection code in the framework, where the reflection code may be stored in generic form in a cloud, and where the reflection code may be read by custom programs that create required end-user documentation.

FIG. 2 illustrates code snippet 210. Code snippet 210 as illustrated in FIG. 2 includes the following snippet of code:

```
implicit val autoDeletes [MySource] = {
  import Auto Deletes._
  AutoDeletes(
    onePerMonth [MySource].latest(12) ++ anyDate[MySource].latest(14)
  )
}
```

As illustrated in FIG. 2, we declare that all data in the MySource source should be deleted, unless it is one of the last 14 days of data, or it is required to make sure that at least one day is available from each of the last 12 months.

FIG. 3 illustrates exemplary potential system elements. As illustrated in FIG. 3, the system may include components including input/output device 310, input/output device 320, processor 330, memory 340, and data store 350.

As will be realized, the systems and methods disclosed herein are capable of other and different embodiments and its several details may be capable of modifications in various respects, all without departing from the invention. For example, specific implementation technology used may be different than those exemplified herein, but would function in a similar manor as described. Accordingly, the drawings and description are to be regarded as illustrative in nature and not in a restrictive or limiting sense.

Figures will be taken as nonlimiting.

1. A framework for abstracting specifics about datasets, the framework comprising:
A plurality of datasets as input sources, where the datasets may include pseudo-datasets;
where data sources may be described as a pair of Scala case classes, the first Scala case class encapsulating a source framework structure of each element in a data source, and the second Scala case class encapsulating model framework specifics of accessing the data source;
where from the pair of Scala case classes, implicit derivation of type classes allow for functionality at compile time, the allowed functionality including multiple of: a source reader, a source data manipulator, a data summarizer, and source writer, data cleanup, and random valid data generation;
and where all objects in a dataset can be described by the same non-recursive data model.

2. The source framework of claim 1, wherein the non-recursive data model may be declared as a non-recursive Scala type.

3. The source framework of claim 1, including functionality available at runtime, including one or more of: AWS S3 to Google CS, Google BigQuery Populator, Dataset cleanup, AWS Athena Populator, Data catalog generation, and Incompatible data detection.

4. The source framework of claim 1, including automatic generation of end-user documentation for all datasets, as code and code comments, where the code structure and comments are extracted by a custom piece of reflection code in the framework, where the reflection code is stored in generic form in a cloud, and where the reflection code may be read by custom programs that create required end-user documentation.

5. The source framework of claim 1, including automatic replication of new and old datasets to one or more of: Athena, BigQuery, and RedShift.

6. The source framework of claim 1, including reading the most recent version of a dataset automatically in jobs.

7. The source framework of claim 1, including handling unavailable data automatically.

8. The source framework of claim 1, where the framework is plugin-based.

9. The source framework of claim 1, including automatic deletion of old datasets based on retention rules.

10. The source framework of claim 1, wherein all datasets are documented as code, and where each dataset may be declared as two Scala classes.

11. The source framework of claim 1, where the source framework supports partitioned file structures.

12. The source framework of claim 1, where the source framework abstracts away source and file systems, each data processing job containing within it an object that specifies the data area being worked on, where the object is used to generate the paths upon read.

13. The source framework of claim 1, including integrated end to end testing of Spark and Cascading jobs with sources, where the source framework contains an abstraction for unit testing, where a complete data job is invoked on data in memory and where the resultant data streams are verified against in-memory data, where each source read by the job has a corresponding memory stream in a test, and each source written has a corresponding verification step in the test, and where source types are used to enforce this correspondence.

14. The source framework of claim 1, including a UI for exploring data sources and how they are used by jobs.

15. The source framework of claim 1, including a read/write logger that records access to datasets during job execution to a database.

16. The model framework of claim 1, including automatic generation of one or both of random and blank instances.

17. The model framework of claim 1, including automatic validation of instances.

18. The model framework of claim 1, including detection of functional type changes between consecutive runs, based on hashes of the code base.

19. The model framework of claim 1, including strongly typed fields leading to fewer runtime bugs.

20. The model framework of claim 1, including custom enumeration types supporting short names and conversion to bit vectors.

21. The model framework of claim 1, including one or more of custom Avro, Parquet, TSV, JSON, and FlatteningTSV writers or readers.
